(19) United States
(12) Patent Application Publication
(10) Pub. No.: US 2026/0053198 A1
(43) Pub. Date: Feb. 26, 2026

(54) CARTRIDGE AND AEROSOL GENERATING DEVICE COMPRISING THE SAME

(71) Applicant: KT&G CORPORATION, Daejeon (KR)

(72) Inventors: Sang Cheol PARK, Gyeonggi-do (KR); Won Kyeong LEE, Gyeonggi-do (KR); Chul Ho JANG, Gyeonggi-do (KR)

(73) Assignee: KT&G CORPORATION, Daejeon (KR)

(21) Appl. No.: 19/270,940

(22) Filed: Jul. 16, 2025

(30) Foreign Application Priority Data
Aug. 20, 2024 (KR) 10-2024-0111632

(51) Int. Cl. A24F 40/53; A24F 40/10; A24F 40/42; A24F 40/485; A24F 40/51; A24F 40/60; G01F 23/263

(52) U.S. Cl. CPC A24F 40/53; A24F 40/10; A24F 40/42; A24F 40/485; A24F 40/51; A24F 40/60; G01F 23/263

(57) ABSTRACT

A cartridge includes a storage unit accommodating an aerosol generating material, an atomizing unit configured to generate an aerosol from the aerosol generating material, and a plurality of electrodes disposed inside the storage unit and configured to detect a remaining amount of the aerosol generating material accommodated in the storage unit.

### CROSS-REFERENCE TO RELATED APPLICATIONS

Pursuant to 35 U.S. C. § 119(a), this application claims the benefit of earlier filing date and right of priority to Korean Patent Application No. 10-2024-0111632 filed on Aug. 20, 2024, the contents of which are all hereby incorporated by reference herein in their entireties.

### BACKGROUND

### 1. Field

Various embodiments relate to a cartridge and an aerosol generating device including the same, and more particularly, to a cartridge with a configuration for detecting the remaining amount of a liquid composition stored in the cartridge, and an aerosol generating device including the same.

### 2. Description of the Related Art

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on heating-type aerosol generating devices has been actively conducted.

Aerosol generating devices may be provided with additional functions that may provide user convenience. For example, an aerosol generating device using a liquid aerosol generating material may have a function of providing information about the remaining amount of an aerosol generating material to users or controlling operations of the aerosol generating device on the basis of the remaining amount of the aerosol generating material.

### SUMMARY

In general, a cartridge of an aerosol generating device storing an aerosol generating material in the form of liquid composition may be used as a consumable. That is, when the aerosol generating material stored in the cartridge is completely consumed, the cartridge needs to be replaced. Even when the cartridge is not the consumable, when the aerosol generating material is completely consumed, a user needs to fill the cartridge with the aerosol generating material to use.

In this regard, when the user fails to visually check the remaining amount of the aerosol generating material inside the cartridge, the replacement timing of the cartridge or the charging timing of the aerosol generating material may not be previously known. In this respect, it is necessary to apply a technique for monitoring the remaining amount of the aerosol generating material to the aerosol generating device.

Embodiments provide a cartridge with a configuration capable of monitoring the remaining amount of an aerosol generating material.

Embodiments provide an aerosol generating device capable of controlling operations of other components in response to the remaining amount of an aerosol generating material stored in a cartridge.

The technical problems of the present disclosure are not limited to the above-described description, and other technical problems may be clearly understood by one of ordinary skill in the art from the embodiments to be described hereinafter.

Additional aspects will be set forth in part in the description which follows and, in part, will be apparent from the description, or may be learned by practice of the presented embodiments of the disclosure.

According to an embodiment, a cartridge includes a storage unit accommodating an aerosol generating material, an atomizing unit configured to generate an aerosol from the aerosol generating material, and a plurality of electrodes disposed inside the storage unit and configured to detect a remaining amount of the aerosol generating material accommodated in the storage unit

According to an embodiment, an aerosol generating device includes a cartridge according to an embodiment and a control unit electrically connected to an electrode, wherein the control unit is configured to determine a remaining amount of an aerosol generating material accommodated in a storage unit in response to a signal generated by the electrode, and control an operation of the aerosol generating device based on the remaining amount.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating device according to an embodiment;

FIG. 2 illustrates an aerosol generating device according to an embodiment;

FIG. 3 illustrates an aerosol generating device according to an embodiment;

FIGS. 4A to 4E are diagrams briefly illustrating a cartridge and an aerosol generating device, according to an embodiment, to which an example of a technique for monitoring the remaining amount of an aerosol generating material is applied;

FIGS. 5A to 5E are diagrams briefly illustrating a cartridge and an aerosol generating device, according to another embodiment, to which another example of a technique for monitoring the remaining amount of an aerosol generating material has been applied;

FIGS. 6A to 6D are diagrams briefly illustrating a cartridge according to another embodiment, to which another example of a technique for monitoring the remaining amount of an aerosol generating material has been applied;

FIG. 7 is a diagram briefly illustrating a cartridge according to another embodiment, to which another example of a technique for monitoring the remaining amount of an aerosol generating material has been applied;

FIGS. 8A and 8B are cross-sectional views of a cartridge according to another embodiment, in which a heating temperature may be adjusted according to the remaining amount of an aerosol generating material;

FIGS. 9A and 9B are cross-sectional views of a cartridge according to another embodiment, in which the opening area of an outlet may be adjusted according to the remaining amount of an aerosol generating material;

FIG. 10 is an exploded perspective view of a cartridge according to another embodiment, storing three types of aerosol generating materials;

FIG. 11A is a cross-sectional view showing the cartridge shown in FIG. 10 in a first state;

FIG. 11B is a cross-sectional view showing the cartridge shown in FIG. 10 in a second state; and

FIG. 12 is an exploded perspective view of a cartridge according to another embodiment, capable of heating each of three types of aerosol generating materials.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

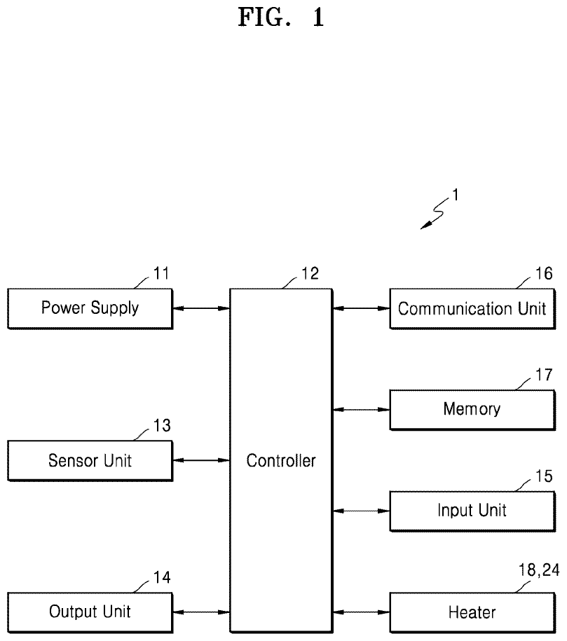

FIG. 1 is a block diagram of an aerosol-generating device according to an embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change and/or aerosol flow may occur in the insertion space of the aerosol-generating article, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

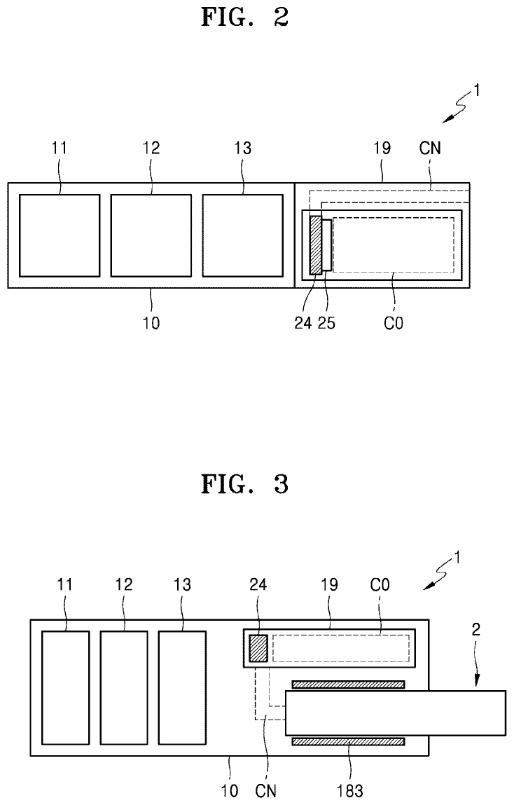

FIG. 2 shows an aerosol-generating device 1 according to an embodiment. According to one embodiment, the aerosol-generating device 1 may include a housing 10, a power supply 11, a controller 12, and/or a sensor unit 13. However, it will be understood by those skilled in the art related to the present embodiment that the components included in the aerosol-generating device 1 are not limited to those shown in FIG. 2 and that some of the components may be omitted or new components may be further included. In the drawings below, a description of configurations identical to those shown in FIG. 1 will be omitted.

According to one embodiment, the housing 10 may include a structure that allows a cartridge 19 to be inserted into or mounted on one side thereof. In this case, the cartridge 19 may be removably coupled to the housing 10.

Although not shown in the drawings, the housing 10 and/or the cartridge 19 may include a mouthpiece. A user may inhale an aerosol while holding the mouthpiece in the mouth.

According to one embodiment, the cartridge 19 may include a chamber C0 containing an aerosol-generating substance. The chamber C0 may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance.

According to one embodiment, a liquid delivery part 25 that is impregnated with (contains) the aerosol-generating substance may be included in the cartridge 19. For example, the liquid delivery part 25 may be impregnated with the aerosol-generating substance supplied from the chamber C0. Here, the liquid delivery part 25 may include a wick formed of, e.g., cotton fiber, ceramic fiber, glass fiber, or porous ceramic. Although not shown in the drawings, the aerosol-generating device 1 may further include a liquid delivery part. In this case, at least a portion of the first liquid delivery part of the cartridge 19 and at least a portion of the second liquid delivery part of the aerosol-generating device 1 may be formed in contact with each other. In this case, the first liquid delivery part and the second liquid delivery part may be implemented in different forms. For example, the first liquid delivery part may include cotton fiber, and the second liquid delivery part may include porous ceramic. Alternatively, the cartridge 19 may not include a liquid delivery part, and the aerosol-generating substance in the cartridge 19 may be delivered to the liquid delivery part of the aerosol-generating device 1.

According to one embodiment, the housing 10 and/or the cartridge 19 may be provided with an airflow channel through which air flows.

For example, the housing 10 may include a structure allowing outside air to be introduced into the housing 10 in the state in which the cartridge 19 is coupled thereto. In an example, an air inlet through which outside air may be introduced into the housing 10 may be formed in one side surface of the housing 10. The air inlet may also be formed in the lower end surface of the housing 10. Outside air introduced into the housing 10 through the air inlet may pass through the cartridge 19, and then may flow toward the user's oral cavity through the airflow channel CN. The outside air introduced through the air inlet may flow to the user's oral cavity through the airflow channel CN via the cartridge 19.

For example, the airflow channel CN may be included in the cartridge 19. The airflow channel CN may connect the chamber (e.g., an atomization chamber) in which the cartridge heater 24 or the liquid delivery part 25 is disposed to the outside of the housing 10 and/or the cartridge 19. In more detail, one end of the airflow channel CN may be open to the chamber (e.g., the atomization chamber) in which the cartridge heater 24 or the liquid delivery part 25 is disposed, and the other end thereof may communicate with the mouthpiece. The airflow channel CN may be elongated from one side of the chamber C0 of the cartridge 19 in the longitudinal direction of the cartridge 19. The airflow channel CN may also be elongated in the longitudinal direction of the cartridge 19 through the chamber C0 of the cartridge 19. The airflow channel CN may also communicate with a separate mouthpiece provided at the housing 10.

According to one embodiment, the cartridge heater 24 may heat the aerosol-generating substance contained in the cartridge 19. For example, the cartridge heater 24 may include an electro-resistive heater and/or an induction heater. In an example, the electro-resistive heater may include an electro-resistive material, and may generate heat as current flows through the electro-resistive material. In another example, in the case of an induction heater, the aerosol-generating device 1 may include an induction coil (not shown) provided around the induction heater. The induction heater may include a susceptor, and may generate heat based on a magnetic field generated by the induction coil (not shown). The cartridge heater 24 may be formed in a coil shape surrounding (or wound around) the liquid delivery part included in the cartridge 19 and/or the aerosol-generating device 1 and/or in a shape (e.g., a pattern shape) contacting one side of the liquid delivery part.

According to one embodiment, the cartridge heater 24 may be included in the cartridge 19. If the cartridge 19 is formed to be removable from the housing 10, the cartridge heater 24 may be removed from the aerosol-generating device 1 together with the cartridge 19. Unlike the configuration shown in the drawings, the cartridge heater 24 may be included in the aerosol-generating device 1. For example, the cartridge heater 24 may be included inside the housing 10. Meanwhile, the cartridge heater 24 may be included in a form that is removable from the housing 10 separately from (i.e., independently of) the cartridge 19. In other words, the cartridge heater 24 may or may not be removed from the housing 10 regardless of removal of the cartridge 19.

According to one embodiment, an aerosol may be generated based on generation of heat by the cartridge heater 24. As the liquid delivery part 25 is heated by the cartridge heater 24, an aerosol may be generated. For example, as the aerosol-generating substance impregnated in the liquid delivery part 25 is heated by the cartridge heater 24, vapor may be generated from the aerosol-generating substance, and an aerosol may be generated as the generated vapor is mixed with the outside air introduced into the cartridge 19. The aerosol generated by the cartridge heater 24 may be inhaled into the user's oral cavity through the airflow channel CN.

According to one embodiment, the cartridge 19 may be integrally formed with the aerosol-generating device 1 (e.g., the housing 10). The cartridge 19 may be formed so as not to be removed from the aerosol-generating device 1 by the user. Even in this case, the cartridge 19 and/or the aerosol-generating device 1 may include at least one liquid delivery part, and an aerosol may be generated based on heating of the liquid delivery part 25 by the cartridge heater 24 included in the aerosol-generating device 1 or the cartridge 19. The generated aerosol may be inhaled into the user's oral cavity through the airflow channel CN.

FIG. 3 shows an aerosol-generating device 1 according to an embodiment.

According to one embodiment, the aerosol-generating device 1 may include a housing 10, a power supply 11, a controller 12, a sensor unit 13, and/or a heater 183 and 24 (e.g., the heater 18 and 24 in FIG. 1). However, it will be understood by those skilled in the art related to the present embodiment that the components included in the aerosol-generating device 1 are not limited to those shown in FIG. 3 and that some of the components may be omitted or new components may be further included. In the drawings below, a description of configurations identical to those shown in FIG. 1 will be omitted.

According to one embodiment, the housing 10 may provide a space that is open upwardly to allow the aerosol-generating article 2 to be inserted thereinto (hereinafter referred to as an insertion space). The insertion space may be formed so as to be depressed in the housing 10 to a predetermined depth so that at least a portion of the aerosol-generating article 2 may be inserted thereinto. The lower end of the aerosol-generating article 2 may be inserted into the housing 10, and the upper end of the aerosol-generating article 2 may protrude outside the housing 10.

Unlike the configuration shown in the drawings, the cartridge 19 may provide an insertion space for receiving the aerosol-generating article 2. In this case, the insertion space may be formed so as to be depressed in the cartridge 19 to a predetermined depth so that at least a portion of the aerosol-generating article 2 may be inserted thereinto. The lower end of the aerosol-generating article 2 may be inserted into the cartridge 19, and the upper end of the aerosol-generating article 2 may protrude outside the cartridge 19. In this case, the aerosol-generating device 1 may not include the heater 183.

According to one embodiment, the depth of the insertion space may be equal to or greater than the length of a region of the aerosol-generating article 2 in which an aerosol-generating substance and/or a medium is contained. A user may inhale air while holding the externally exposed upper end of the aerosol-generating article 2 in the mouth.

According to one embodiment, the heater 183 may heat the aerosol-generating article 2. The heater 183 may be elongated upwardly around the space into which the aerosol-generating article 2 is inserted (i.e., the insertion space). In an example, the heater 183 may have a tube shape (e.g., a cylindrical shape) with a cavity formed therein. The heater 183 may include a shape including a cavity formed therein and surrounding the cavity. In this case, the heater 183 may be supported by a polyimide film. The heater supported by this film may be referred to as a film heater. The heater 183 may be disposed so as to surround at least a portion of the insertion space. The heater 183 may heat the outer side of the aerosol-generating article 2 inserted into the cavity. In the present disclosure, the heater 183 may be referred to as an external heating-type heater, which heats the outer side of the aerosol-generating article 2. Meanwhile, a thermally insulating material may be disposed outside the heater 183. Accordingly, the amount of heat emitted from the heater 183 in the radially outward direction and released outside the housing 10 may be reduced.

According to one embodiment, the heater 183 may include an electro-resistive heater and/or an induction heater.

For example, the electro-resistive heater may include an electro-resistive material, and may generate heat as current flows through the electro-resistive material. In this case, the electro-resistive heater may be electrically connected to the power supply 11, and may directly generate heat using current received from the power supply 11.

For example, in the case of an induction heater, the aerosol-generating device 1 may further include an induction coil (not shown) surrounding at least a portion of the heater 183 (e.g., disposed outside the heater 183 so as to correspond to the length of at least a portion of the heater 183). In this case, a magnetic flux concentrator may be further provided outside the induction coil (not shown) in order to increase efficiency of induction heating. The induction heater may include a susceptor, and may generate heat based on a magnetic field generated by the induction coil (not shown).

According to one embodiment, the heater 183 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 183 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively. In addition, three or more heaters and/or three or more induction coils may be included.

Unlike the configuration shown in the drawings, the aerosol-generating device 1 may not include the heater 183. The aerosol-generating article 2 may be directly or indirectly heated by the cartridge heater 24 or may not be substantially heated. Indirect heating may mean that the aerosol-generating article 2 is heated by receiving heat contained in the aerosol during the process in which the aerosol generated by the cartridge heater 24 passes through the aerosol-generating article 2. In this case, the aerosol-generating device 1 may be referred to as a non-heating-type (or indirect heating-type) aerosol-generating device. An additive such as an alkaline substance may be contained in the aerosol-generating rod of the aerosol-generating article 2. Based on the alkaline substance, nicotine contained in the aerosol-generating rod may have an alkaline pH (e.g., pH 7.0 or higher). This alkaline nicotine may flow to the user's oral cavity together with the aerosol introduced into the aerosol-generating article 2 from the cartridge 19 to be described later.

Unlike the configuration shown in the drawings, the heater 183 may include an internal heating-type heater. For example, the internal heating-type heater may include various heating elements, such as a rod-shaped heating element, a tubular heating element, a plate-shaped heating element, or a needle-shaped heating element. The internal heating-type heater may be inserted through the lower portion of the aerosol-generating article 2, and may be set to heat the inner side of the aerosol-generating article 2.

According to one embodiment, the cartridge 19 may be removably coupled to the housing 10. For example, a space may be formed in one side of the housing 10, and at least a portion of the cartridge 19 may be inserted into the space formed in one side of the housing 10 so that the cartridge 19 is mounted to the housing 10. Alternatively, the cartridge 19 may be integrally formed with the housing 10.

According to one embodiment, the aerosol-generating device 1 and/or the cartridge 19 may be provided with an airflow channel through which air flows. For example, the housing 10 may include a structure allowing outside air to be introduced into the housing 10 in the state in which the cartridge 19 is inserted thereinto. The introduced air may pass through the cartridge 19, may be introduced into the insertion space through the airflow channel CN, and then may flow to the user's oral cavity. The airflow channel CN may include various structures for reducing residual droplets or making the flow of air smooth.

Although it is illustrated in FIG. 3 that the cartridge 19 is located beside the aerosol-generating article 2 and the airflow channel CN is formed from the side surface of the aerosol-generating article 2 to the lower end (i.e., upstream side) of the aerosol-generating article 2, the positions of the cartridge 19 and the airflow channel CN are not limited thereto. For example, the cartridge 19 may be located adjacent to the lower end (i.e., upstream side) of the aerosol-generating article 2. In this case, the airflow channel CN may be formed in a substantially straight shape to connect the cartridge 19 to the lower end (i.e., upstream side) of the aerosol-generating article 2.

According to one embodiment, the cartridge 19 may include a storage part C0 that contains an aerosol-generating substance, a cartridge heater 24, and/or a liquid delivery part that is impregnated with (contains) the aerosol-generating substance. The liquid delivery part 25 may be impregnated with the aerosol-generating substance supplied from the chamber C0. For example, the liquid delivery part may include a wick formed of, e.g., cotton fiber, ceramic fiber, glass fiber, or porous ceramic.

According to one embodiment, the cartridge heater 24 may heat the aerosol-generating substance contained in the cartridge 19. For example, the cartridge heater 24 may include an electro-resistive heater and/or an induction heater.

In an example, the electro-resistive heater may include an electro-resistive material, and may generate heat as current flows through the electro-resistive material. In another example, in the case of an induction heater, the aerosol-generating device 1 may further include an induction coil (not shown) provided around the induction heater. The induction heater may include a susceptor, and may generate heat based on a magnetic field generated by the induction coil (not shown). The cartridge heater 24 may be formed in a coil shape surrounding (or wound around) the liquid delivery part and/or in a shape (e.g., a patterned shape) contacting one side of the liquid delivery part.

Unlike the configuration shown in the drawings, the cartridge heater 24 may be included in the aerosol-generating device 1. For example, the cartridge heater 24 may be included inside the housing 10. In this case, the cartridge 19 and the cartridge heater 24 may be separated by removal of the cartridge 19.

According to one embodiment, an aerosol may be generated based on generation of heat by the cartridge heater 24. For example, as the aerosol-generating substance impregnated in the liquid delivery part is heated by the cartridge heater 24, vapor may be generated from the aerosol-generating substance, and an aerosol may be generated as the generated vapor is mixed with the outside air introduced into the cartridge 19. The aerosol generated by the cartridge heater 24 may be introduced into the aerosol-generating article 2 through the airflow channel CN. While the aerosol passes through the aerosol-generating article 2, tobacco or a flavoring substance may be added to the aerosol, and the aerosol containing the tobacco or the flavoring substance may be inhaled into the user's oral cavity through one end of the aerosol-generating article 2.

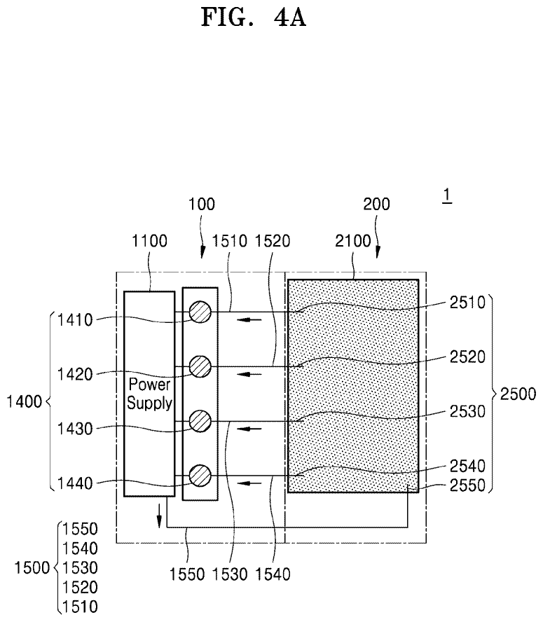

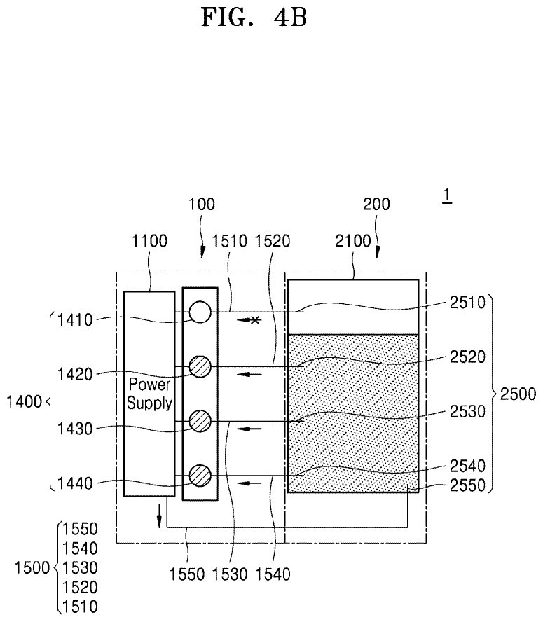

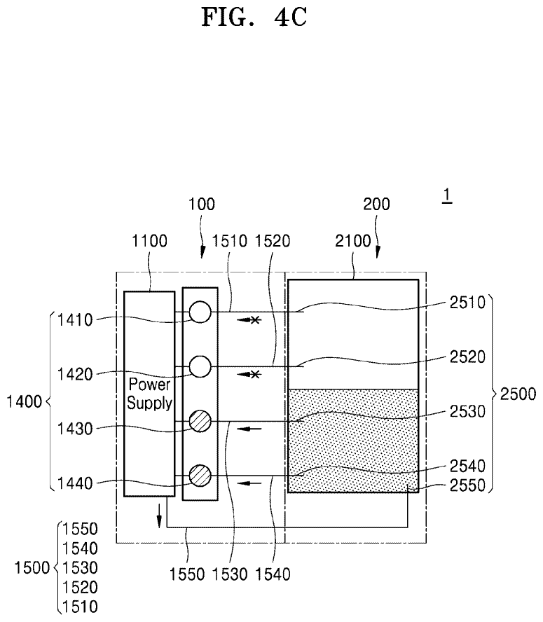

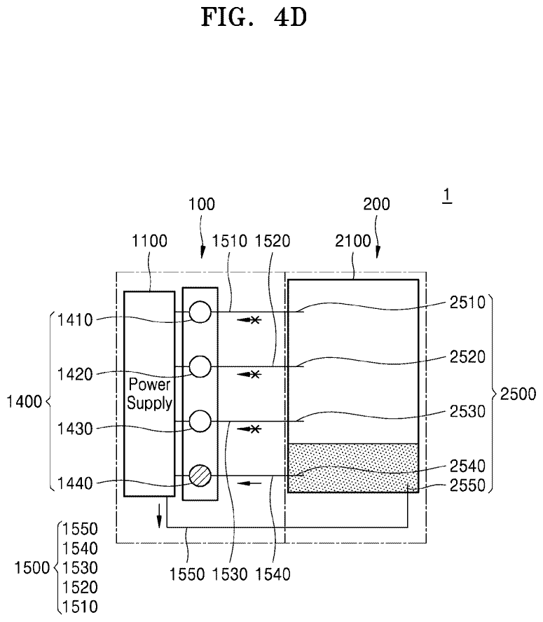

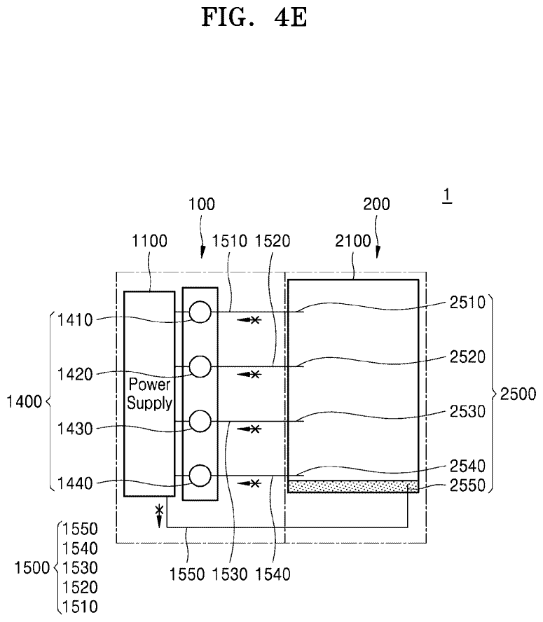

FIGS. 4A to 4E are diagrams briefly illustrating a cartridge and an aerosol generating device according to an embodiment to which an example of a technique for monitoring the remaining amount of an aerosol generating material is applied.

Referring to FIGS. 4A to 4E, an aerosol generating device 1 according to an embodiment may include a main body 100 and a cartridge 200.

The main body 100 may occupy a part of the exterior appearance of the aerosol generating device 1. The cartridge 200 may be detachably coupled to a part of the main body 100 to form a part of the exterior appearance of the aerosol generating device 1 together with the main body 100.

The embodiment is not limited to an example in which the cartridge 200 is detachably coupled to the main body 100, and the cartridge 200 may be integrally formed with the main body 100. However, hereinafter, an embodiment in which the cartridge 200 is detachably coupled to the main body 100 and each of the main body 100 and the cartridge 200 is regarded as one component of the aerosol generating device 1 will be described. In this regard, the remaining components except for the cartridge 200 may be referred to as the main body 100.

Referring to FIGS. 4A to 4E, the main body 100 may include a power supply 1100, an output unit 1400, and a connection unit 1500. In this regard, the power supply 1100 and the output unit 1400 may be respectively the same as the power supply 11 and the output unit 14 described with reference to FIG. 1.

The output unit 1400 may represent the remaining amount of the aerosol generating material accommodated in a storage unit 2100. A control unit may control an output of the output unit 1400 based on the remaining amount of the aerosol generating material. For example, the control unit may control whether the output unit 1400 or each output unit is activated.

In this regard, ‘activation’ may mean that the output unit 1400 indicates that an aerosol generating material is present at a specific location or region. Conversely, ‘inactivation’ may mean that the output unit 1400 indicates that no aerosol generating material is present at a specific location or region.

The output unit 1400 may include four output portions 1410, 1420, 1430, and 1440. Each of the output portions 1410, 1420, 1430, and 1440 may be connected to the power supply 1100 to receive power from the power supply 1100. A user may identify the number of activated output portions 1410, 1420, 1430, and 1440 and determine the remaining amount of the aerosol generating material stored in the storage unit 2100. According to an embodiment, the output unit 1400, which is included in the cartridge 200 rather than the main body 100, may be disposed in the cartridge 200.

The connection unit 1500 electrically connects an electrode 2500 of the cartridge 200 to the output unit 1400 of the main body 100. Five connection units 1510, 1520, 1530, 1540, and 1550 may be disposed. In this regard, five electrodes 2510, 2520, 2530, 2540, and 2550 are also disposed in the cartridge 200, such that the connection units 1510, 1520, 1530, 1540, and 1550 may be respectively connected to the electrodes 2510, 2520, 2530, 2540, and 2550.

Meanwhile, the number of output portions, the number of connection units, and the number of electrodes are not limited to those illustrated. The number of connection units and the number of electrodes are the same, and the number of output portions is one less than those, but according to an embodiment, a more number may be disposed to more sophistically monitor the remaining amount of the aerosol generating material, or a fewer number may be disposed when the need for sophistically monitoring the remaining amount of the aerosol generating material is insufficient.

Referring to FIGS. 4A to 4E, the cartridge 200 may include the storage unit 2100 and the electrode 2500.

The storage unit 2100 is a component for accommodating or storing an aerosol generating material. The storage unit 2100 may correspond to the same component as the chamber C0 described with reference to FIGS. 2 and 3.

The electrode 2500 is a component disposed inside the storage unit 2100 to detect the remaining amount of the aerosol generating material accommodated in the storage unit 2100. As shown, the electrode 2500 may be disposed to protrude from an inner wall of the storage unit 2100, but is not limited thereto.

A plurality of electrodes 2500 may be disposed. The plurality of electrodes 2500 may be spaced apart from each other. As the number of electrodes 2500 increases, sensing accuracy may be improved. That is, the remaining amount of aerosol generating article may be accurately detected.

According to an embodiment, the four electrodes 2510, 2520, 2530, and 2540 protruding from the inner wall or an inner surface of the storage unit 2100 may be spaced apart from each other in a longitudinal direction (e.g., vertical direction) of the storage unit 2100. In this regard, the four electrodes 2510, 2520, 2530, and 2540 may have the same length and may be spaced apart from each other at equal intervals.

For example, the first electrode 2510 may be spaced apart from a bottom surface of the storage unit 2100 by a first distance, and the second electrode 2520 may be spaced apart from the bottom surface of the storage unit 2100 by a second distance different from the first distance.

The four electrodes 2510, 2520, 2530, and 2540 may function as operation electrodes. Unlike the four electrodes 2510, 2520, 2530, and 2540, the fifth electrode 2550, which is the remaining one electrode, may function as a reference electrode. Each of the four operation electrodes 2510, 2520, 2530, and 2540 may be capable of coming into contact with the aerosol generating material according to the remaining amount of the aerosol generating material accommodated in the storage unit 2100.

The first electrode 2510 may be disposed at an uppermost portion among the operation electrodes 2510, 2520, 2530, and 2540. The first electrode 2510 may be connected to the first connection unit 1510. The first electrode 2510 may be connected to the first output portion 1410 through a first connection unit 1510.

The second electrode 2520 may be disposed in a lower portion of the first electrode 2510. The second electrode 2520 may be connected to the second connection unit 1520. The second electrode 2520 may be connected to the second output portion 1420 through the second connection unit 1520.

The third electrode 2530 may be disposed below the second electrode 2520. The third electrode 2530 may be connected to the third connection unit 1530. The third electrode 2530 may be connected to the third output portion 1430 through the third connection unit 1530.

The fourth electrode 2540 may be disposed below the third electrode 2530. The fourth electrode 2540 may be disposed in the lowermost portion among the operation electrodes 2510, 2520, 2530, and 2540. The fourth electrode 2540 may be connected to the fourth connection unit 1540. The fourth electrode 2540 may be connected to the fourth output portion 1440 through the fourth connection unit 1540.

The fifth electrode 2550 may be disposed below the fourth electrode 2540. The fifth electrode 2550 may be disposed in the lowermost portion among all the plurality of electrodes 2500. The fifth electrode 2550 may be connected to the fifth connection unit 1550. The fifth electrode 2550 may be connected to the power supply 1100 through the fifth connection unit 1550.

As shown, the fifth electrode 2550 may be disposed to protrude from a lower wall of the storage unit 2100, but is not limited thereto. Like the other electrodes 2510, 2520, 2530, and 2540, the fifth electrode 2550 may be disposed to protrude from the inner wall of the storage unit 2100.

According to an embodiment, when the operation electrodes 2510, 2520, 2530, and 2540 and the reference electrode 2550 are in contact with the aerosol generating material, current may flow between the operation electrodes 2510, 2520, 2530, and 2550, the aerosol generating material, and the reference electrode 2550.

Specifically, a closed loop connected to the power supply 1100, the connection unit 1500, the fifth electrode 2550 which is the reference electrode, the aerosol generating material, the four electrodes 2510, 2520, 2530, and 2540 which are the operation electrodes, the connection unit 1500, the output unit 1400, and again the power supply 1100 may be formed again. The current may flow through the closed loop. In this regard, because the operation electrodes 2510, 2520, 2530, and 2540 are four, four closed loops of the corresponding path may be formed.

Accordingly, according to whether the current flows through the four electrodes 2510, 2520, 2530, and 2540, which are operation electrodes, it may be determined whether the four output units 1410, 1420, 1430, and 1440 respectively connected to the electrodes 2510, 2520, 2530, and 2540 are activated.

In order for the current to flow through the operation electrodes 2510, 2520, 2530, and 2540, the operation electrodes 2510, 2520, 2530, and 2540 and the reference electrode 2550 need to be in contact with the aerosol generating material. In this regard, whether the electrode 2500 is in contact with the aerosol generating material may be affected by the remaining amount of the aerosol generating material stored in the storage unit 2100. Accordingly, the four output portions 1410, 1420, 1430, and 1440 may indicate the remaining amount of the aerosol generating material.

Referring to FIG. 4A, the storage unit 2100 is fully filled with the aerosol generating material. In this case, because all four operation electrodes 2510, 2520, 2530, and 2540 are in contact with the aerosol generating material, the current may flow through each of the operation electrodes 2510, 2520, 2530, and 2540. Accordingly, all four output portions 1410, 1420, 1430, and 1440 may be activated.

Referring to FIG. 4B, about 25% of the aerosol generating material is consumed. In this case, the first electrode 2510 disposed on the uppermost portion may no longer be in contact with the aerosol generating material. Accordingly, because no current flows through the first electrode 2510, the first output portion 1410 connected to the first electrode 2510 may be deactivated.

Referring to FIG. 4C, about half of the aerosol generating material is consumed. In this case, the second electrode 2520 disposed second from the top may no longer be in contact with the aerosol generating material. Accordingly, because no current flows through the second electrode 2520, the second output portion 1420 connected to the second electrode 2520 may also be deactivated.

Referring to FIG. 4D, about 75% of the aerosol generating material is consumed. In this case, the third electrode 2530 disposed third from the top may no longer be in contact with the aerosol generating material. Accordingly, because no current flows through the third electrode 2530, the third output portion 1430 connected to the third electrode 2530 may also be deactivated.

Referring to FIG. 4E, about 90% of the aerosol generating material is consumed. In this case, the fourth electrode 2540 disposed fourth from the top may no longer be in contact with the aerosol generating material. Accordingly, because no current flows through the fourth electrode 2540, the fourth output portion 1440 connected to the fourth electrode 2540 may also be deactivated.

When all the operation electrodes 2510, 2520, 2530, and 2540 are not in contact with the aerosol generating material, because the closed loop is no longer formed, in this case, no current may flow in the reference electrode 2550.

According to an embodiment, the control unit electrically connected to the electrode 2500 may monitor the remaining amount of the aerosol generating material through whether the current flows through the electrode 2500, and the user may determine the remaining amount of the aerosol generating material through whether the output unit 1400 is activated.

In addition, the control unit may determine the remaining amount of the aerosol generating material accommodated in the storage unit 2100 in response to a signal generated by the electrode 2500, and control the operation of the aerosol generating device 1 based on the remaining amount. In this regard, the signal generated by the electrode 2500 may refer to current itself flowing through the electrode 2500 or a signal based on the current.

The aerosol generating device 1 according to an embodiment may further include a remaining amount detection sensor (not shown). The remaining amount detection sensor may generate a signal in response to a change in the remaining amount of the aerosol generating material accommodated in the storage unit 2100.

When the remaining amount detection sensor generates the signal in response to the signal generated by the electrode 2500, the control unit may determine the remaining amount of the aerosol generating material accommodated in the storage unit 2100 based on the signal generated by the remaining amount detection sensor and control the operation of the aerosol generating device 1.

For example, the aerosol generating device 1 according to an embodiment may include a current sensor (not shown). The current sensor may be connected to the electrode 2500 or the connection unit 1500. The current sensor may generate a signal in response to a current value or a change in current flowing through the electrode 2500 or the connection unit 1500. For example, the current sensor may generate the signal when the current flows through the electrode 2500 or the connection unit 1500. In this case, the signal generated by the current sensor, which is the remaining amount detection sensor, may refer to current itself flowing through the current sensor or a signal based on the current.

The control unit (not shown) may determine whether current flows through the electrode 2500 based on the signal generated by the current sensor, and determine the remaining amount of the aerosol generating material stored in the cartridge 200 through the determination.

As another example, the control unit may monitor the remaining amount of the aerosol generating material not only through current but also through a potential difference (voltage). In this case, the aerosol generating device 1 may include a potential difference sensor (voltage sensor).

One end of the potential difference sensor may be connected to the fifth electrode 2550 which is the reference electrode or the fifth connection unit 1550, and the other end of the potential difference sensor may be connected to the four electrodes 2510, 2520, 2530, and 2540 which are operation electrodes or the four connection units 1510, 1520, 1430, and 1540. Because four operation electrodes 2510, 2520, 2530, and 2540 are disposed, a total of four potential difference sensors may be disposed, but the embodiment is not limited to the above-described number of potential difference sensors.

Different voltages may be applied between the reference electrode 2550 and the operation electrodes 2510, 2520, 2530, and 2540 according to the remaining amount of the aerosol generating material accommodated in the storage unit 2100. In other words, according to whether each of the operation electrodes 2510, 2520, 2530, and 2540 is in contact with the aerosol generating material, the magnitude of the voltage detected by the potential difference sensor may be different.

For example, the magnitude of a voltage may be different due to a change in a resistance value. As another example, the magnitude of the voltage may be different due to a change in a dielectric constant or capacitance. As another example, the magnitude of the voltage may be different due to a change in an inductance value.

The potential difference sensor may generate a signal in response to the magnitude of voltages applied to both ends or a change in the voltages. In this case, the signal generated by the potential difference sensor, which is he remaining amount detection sensor, may refer to a voltage itself applied between a plurality of electrodes (e.g., operation electrodes and a reference electrode) or a signal based on the voltage. In addition, the signal may refer to a voltage itself applied to the potential difference sensor or a signal based on the voltage.

The control unit may determine whether the electrode 2500 contacts the aerosol generating material based on the signal generated by the potential difference sensor, and determine the remaining amount of the aerosol generating material stored in the cartridge 200 through the determination.

The control unit may determine the remaining amount of the aerosol generating material and control the operation of the aerosol generating device 1. For example, the control unit may control whether each of the output portions 1410, 1420, 1430, and 1440 of the output unit 1400 is activated.

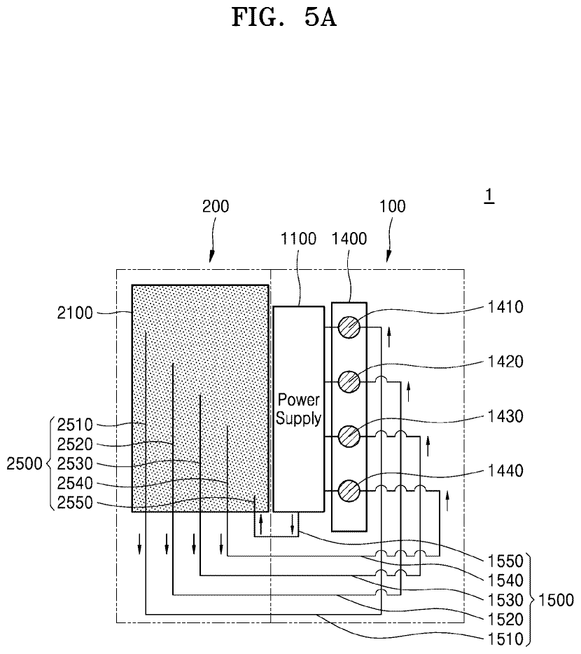

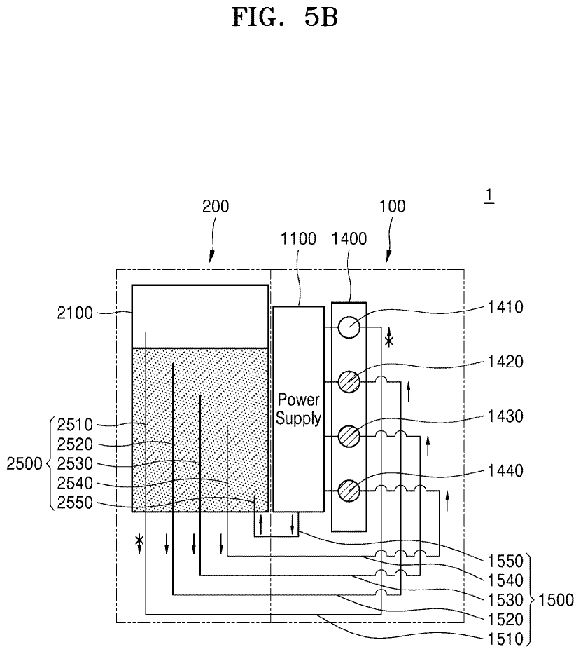

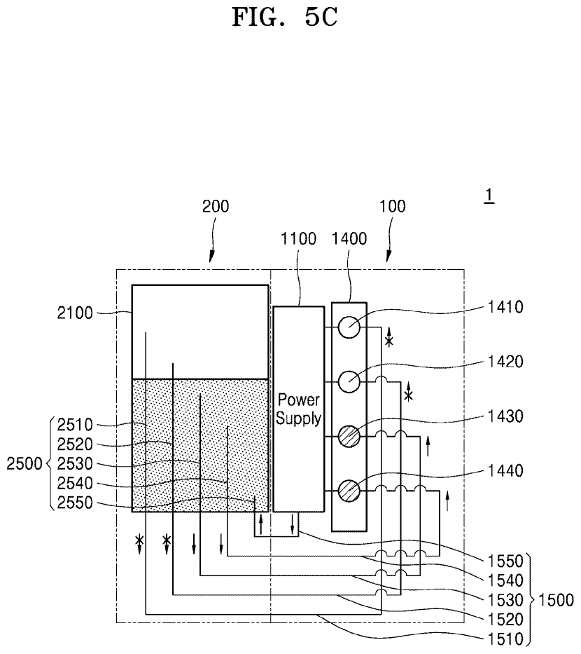

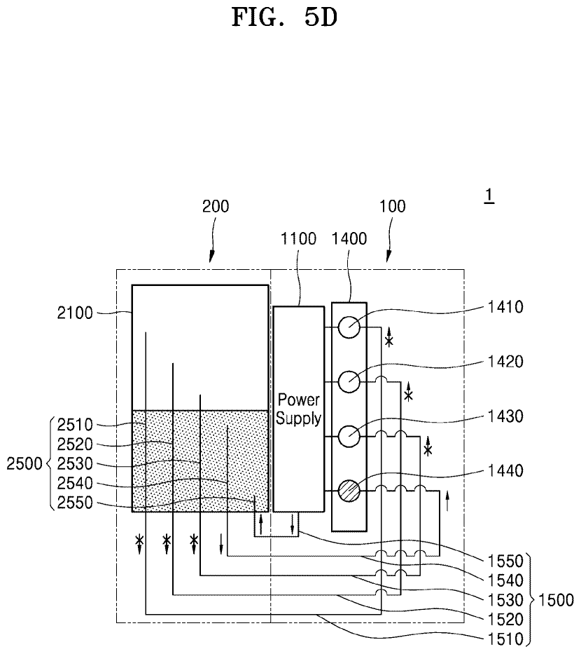

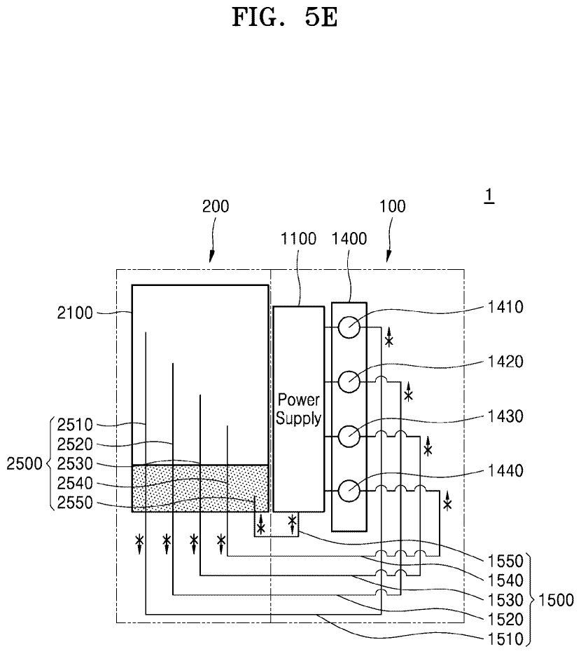

FIGS. 5A to 5E are diagrams briefly illustrating a cartridge and an aerosol generating device according to another embodiment to which another example of a technique for monitoring the remaining amount of an aerosol generating material has been applied.

Referring to FIGS. 5A to 5E, the aerosol generating device 1 according to another embodiment may include the main body 100 and a cartridge 300. Detailed descriptions of the configuration and effect of the aerosol generating device 1 which are redundant with those of FIGS. 4A to 4E are omitted.

According to another embodiment, the plurality of electrodes 2500 may protrude from a lower wall of the storage unit 2100. The plurality of electrodes 2500 may be spaced apart from each other in a direction (e.g., a horizontal direction) crossing a longitudinal direction (e.g., a vertical direction) of the storage unit 2100. In this regard, the plurality of electrodes 2500 may have different lengths and be spaced apart from each other at equal intervals.

For example, the first electrode 2510 may extend by a first length from a bottom surface of the storage unit 2100, and the second electrode 2520 may extend by a second length different from the first length from the bottom surface of the storage unit 2100. The first electrode 2120 and the second electrode 2520 may be spaced apart from each other in a direction crossing the longitudinal direction of the storage unit 2100.

In order to minimize a part of each electrode 2500 in contact with the aerosol generating material, only one end of the electrode 2500 may be exposed to the aerosol generating material and the remaining part may be coated with a waterproof material. In this regard, one end of the electrode 2500 may refer to an end farthest from the bottom surface of the storage unit 2100. As shown, distances from the bottom surface of the storage unit 2100 to one end of each electrode 2500 may be different.

The part coated with the waterproof material may protect the electrode 2500 so that the electrode 2500 is not in contact with the aerosol generating material. Contact between the electrode 2500 and the aerosol generating material may be blocked by waterproof coating. Accordingly, when sensing the remaining amount of the aerosol generating material, occurrence of noise may be prevented.

For example, when one end of the electrode 2500 is in contact with the aerosol generating material, current may flow through the electrode 2500. However, when only the part of the electrode 2500 coated with the waterproof material is in contact with the aerosol generating material, because the electrode 2500 is not in contact with the aerosol generating material, no current may flow through the electrode 2500.

Hereinafter, the contact of the electrode 2500 with the aerosol generating material may mean that one end of the electrode 2500 exposed to the aerosol generating material is in contact with the aerosol generating material because it is not coated with the waterproof material.

The first electrode 2510 may extend the longest among the operation electrodes 2510, 2520, 2530, and 2540. The length of the second electrode 2520 may be less than the length of the first electrode 2510. The length of the third electrode 2530 may be less than the length of the second electrode 2520. The length of the fourth electrode 2540 may be less than the length of the third electrode 2530. The length of the fifth electrode 2550, which is a reference electrode, may be less than the lengths of all the operation electrodes 2510, 2520, 2530, and 2540.

According to another embodiment, when the operation electrodes 2510, 2520, 2530, and 2540 and the reference electrode 2550 are in contact with the aerosol generating material, current may flow between the operation electrodes 2510, 2520, 2530, and 2550, the aerosol generating material, and the reference electrode 2550.

Referring to FIG. 5A, the storage unit 2100 is fully filled with the aerosol generating material. In this case, because one end of each of all four operation electrodes 2510, 2520, 2530, and 2540 are in contact with the aerosol generating material, the current may flow through each of the operation electrodes 2510, 2520, 2530, and 2540. Accordingly, all four output portions 1410, 1420, 1430, and 1440 may be activated.

Referring to FIG. 5B, about 25 % of the aerosol generating material is consumed. In this case, because a liquid level of the aerosol generating material is lower than that of one end of the first electrode 2510 with respect to a bottom surface of the storage unit 2100, the first electrode 2510 may no longer be in contact with the aerosol generating material. Accordingly, because no current flows through the first electrode 2510, the first output portion 1410 connected to the first electrode 2510 may be deactivated.

Referring to FIG. 5C, about half of the aerosol generating material is consumed. In this case, because the liquid level of the aerosol generating material is lower than that of one end of the second electrode 2520 with respect to the bottom surface of the storage unit 2100, the second electrode 2510 may no longer be in contact with the aerosol generating material. Accordingly, because no current flows through the second electrode 2520, the second output portion 1420 connected to the second electrode 2520 may also be deactivated.

Referring to FIG. 5D, about 75% of the aerosol generating material is consumed. In this case, because the liquid level of the aerosol generating material is lower than that of one end of the third electrode 2530 with respect to the bottom surface of the storage unit 2100, the third electrode 2530 may no longer be in contact with the aerosol generating material. Accordingly, because no current flows through the third electrode 2530, the third output portion 1430 connected to the third electrode 2530 may also be deactivated.

Referring to FIG. 5E, about 90% of the aerosol generating material is consumed. In this case, because the liquid level of the aerosol generating material is lower than that of one end of the fourth electrode 2540 with respect to the bottom surface of the storage unit 2100, the fourth electrode 2540 may no longer be in contact with the aerosol generating material. Accordingly, because no current flows through the fourth electrode 2540, the fourth output portion 1440 connected to the fourth electrode 2540 may also be deactivated.

When all the operation electrodes 2510, 2520, 2530, and 2540 are not in contact with the aerosol generating material, because a closed loop is no longer formed, in this case, no current may flow in the reference electrode 2550.

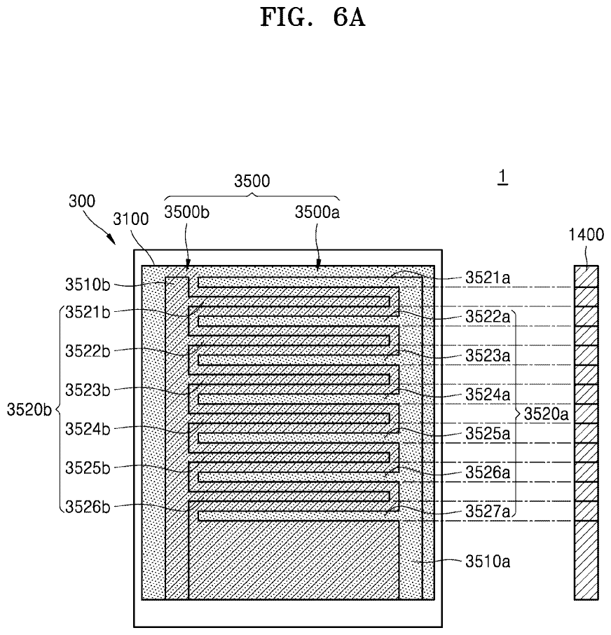

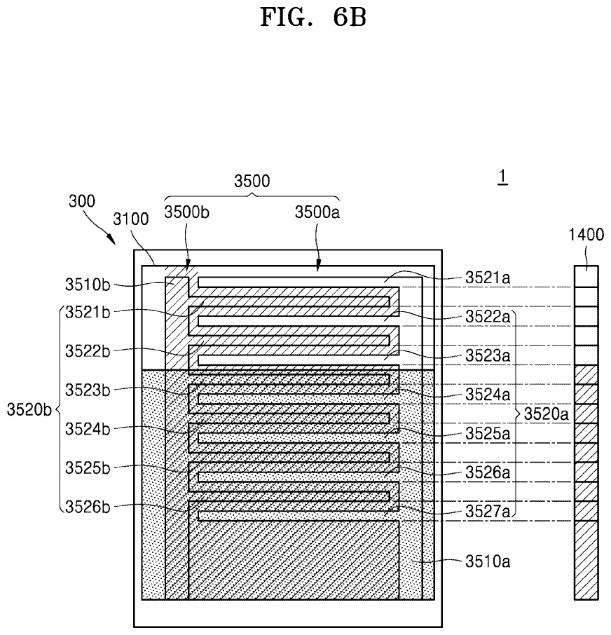

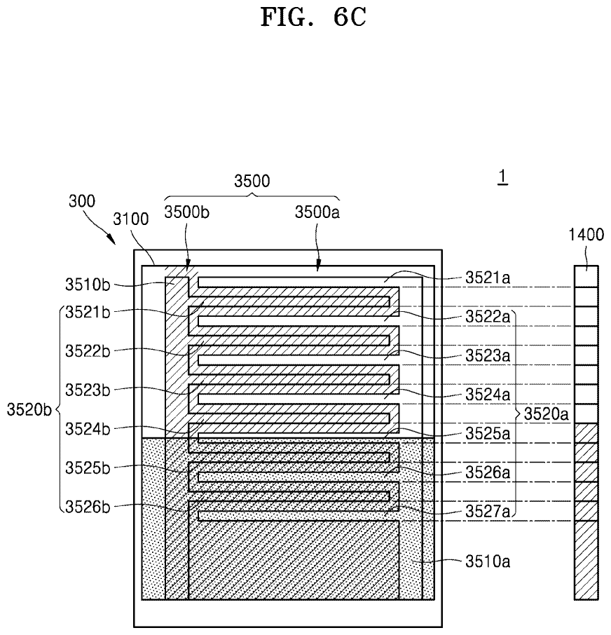

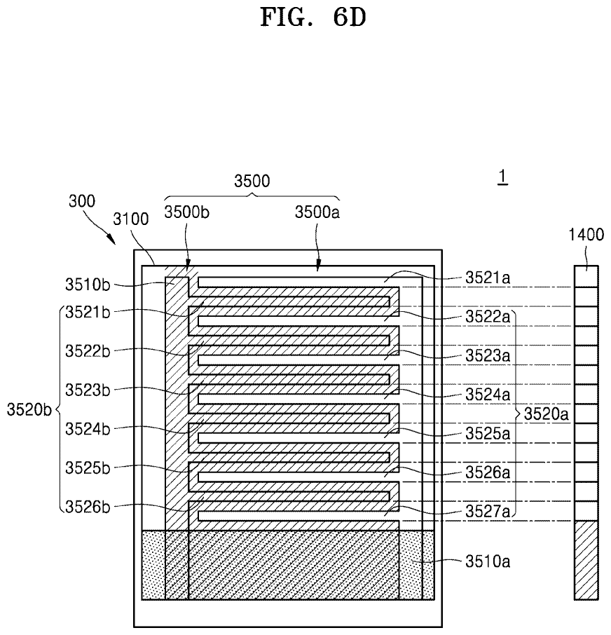

FIGS. 6A to 6D are diagrams briefly illustrating a cartridge according to another embodiment to which another example of a technique for monitoring the remaining amount of an aerosol generating material has been applied.

Referring to FIGS. 6A to 6D, the aerosol generating device 1 according to another embodiment may include the main body 100 and the cartridge 300. Detailed descriptions of the configuration and effect of the aerosol generating device 1 which are redundant with those of FIGS. 4A to 4E are omitted.

The main body 100 may include the output unit 1400. The output unit 1400 may perform the same function as described above. The output unit 1400, which is included in the cartridge 300 rather than the main body 100, may be disposed in the cartridge 300.

The cartridge 300 may include a storage unit 3100 and a pattern electrode 3500. The storage unit 3100 may perform the same function as described above. The pattern electrode 3500 serves as the electrode 2500 shown in FIGS. 4A to 4E.

The electrodes 2500 shown in FIGS. 4A to 4E may be disposed in a certain pattern on an inner wall of the storage unit 3100. The electrode 2500 having the certain pattern shape may be referred to as a pattern electrode 3500.

Two pattern electrodes 3500 may be disposed. The two pattern electrodes 3500 including a first pattern electrode 3500a and a second pattern electrode 3500b may be disposed in a pair. The first pattern electrode 3500a and the second pattern electrode 3500b may be engaged while facing each other. However, the first pattern electrode 3500a and the second pattern electrode 3500b may not cross each other. That is, the first pattern electrode 3500a and the second pattern electrode 3500b may not be physically connected to each other. Each of the two pattern electrodes 3500 may be electrically connected to the power supply 1100.

The electrode pattern of the pattern electrode 3500 may include vertical regions 3510a and 3510b extending in a longitudinal direction (e.g., vertical direction) of the storage unit 3100 and a plurality of horizontal regions 3520a and 3520b extending in a direction (e.g., horizontal direction) crossing the longitudinal direction of the storage unit 3100 from the vertical regions 3510a and 3510b and spaced apart from each other.

In this regard, the plurality of horizontal regions 3520a of the first pattern electrode 3500a and the plurality of horizontal regions 3520b of the second pattern electrode 3500b may be alternately disposed in the longitudinal direction of the storage unit 3100.

As shown, in the first pattern electrode 3500a, one vertical region 3510a may be disposed, and seven horizontal regions 3520a may be disposed. In the second pattern electrode 3500b, one vertical region 3510b may be disposed, and six horizontal regions 3520b may be disposed. However, the number of horizontal regions is not limited to that shown.

According to another embodiment, when each of the two pattern electrodes 3500 is in contact with an aerosol generating material, current may flow between the first pattern electrode 3500a, the aerosol generating material, and the second pattern electrode 3500b.

Specifically, a closed loop connected to the power supply 1100, the vertical region 3510a of the first pattern electrode 3500a, the horizontal region 3520a of the first pattern electrode 3500a, the aerosol generating material, the vertical region 3510b of the second pattern electrode 3500b, and again the power supply 1100 may be formed so that the current may flow through the closed loop.

Similarly, a closed loop connected to the power supply 1100, the vertical region 3510a of the first pattern electrode 3500a, the aerosol generating material, the horizontal region 3520b of the second pattern electrode 3500b, the vertical region 3510b of the second pattern electrode 3500b, and again the power supply 1100 is formed so that the current may flow through the closed loop.

As shown, because the number of horizontal regions 3520a of the first pattern electrode 3500a is seven and the number of horizontal regions 3520b of the second pattern electrode 3500b is six, thirteen closed loops of the corresponding path may be formed, but the embodiment is not limited thereto.

According to another embodiment, each of the ‘at least one of the plurality of horizontal regions 3520a of the first pattern electrode 3500a’ and the ‘vertical region 3510b of the second pattern electrode 3500b’ may be in contact with the aerosol generating material according to the remaining amount of the aerosol generating material accommodated in the storage unit 3100.

When each of ‘at least one of the plurality of horizontal regions 3520a of the first pattern electrode 3500a’ and ‘the vertical region 3510b of the second pattern electrode 3500b’ is in contact with the aerosol generating material, current may flow between the ‘at least one of the plurality of horizontal regions 3520a of the first pattern electrode 3500a’, the aerosol generating material, and ‘the vertical region 3510b of the second pattern electrode 3500b’.

In this regard, according to whether the current flows through the horizontal regions 3520a and 3520b, whether an output portion of the output unit 1400 connected to each of the horizontal regions 3520a and 3520b may be activated may be determined.

In order for the current to flow through the horizontal regions 3520a and 3520b, the horizontal regions 3520a and 3520b need to be in contact with the aerosol generating material. In this regard, whether the horizontal regions 3520a and 3520b are in contact with the aerosol generating material may be affected by the remaining amount of the aerosol generating material stored in the storage unit 3100. Accordingly, the output unit 1400 may represent the remaining amount of the aerosol generating material.

Referring to FIG. 6A, the storage unit 3100 is fully filled with the aerosol generating material. In this case, because all the horizontal regions 3520a and 3520b are in contact with the aerosol generating material, the current may flow through each of the horizontal regions 3520a and 3520b. Accordingly, all output portions of the output unit 1400 may be activated.

Referring to FIG. 6B, about 30% of the aerosol generating material is consumed. In this regard, five horizontal regions 3521a, 3521b, 3522a, 3522b, and 3523a from the top may no longer be in contact with the aerosol generating material. Accordingly, because no current flows through the five horizontal regions 3521a, 3521b, 3522a, 3522b, and 3523a, five output portions from the top among fourteen output portions of the output unit 1400 may be deactivated.

Referring to FIG. 6C, about 60% of the aerosol generating material is consumed. In this case, in addition to the five horizontal regions 3521a, 3521b, 3522a, 3522b, and 3523a that are not already in contact with the aerosol generating material, three horizontal regions 3523b, 3524a, and 3524b disposed therebelow may also no longer be in contact with the aerosol generating material. Accordingly, because no current flows through the three horizontal regions 3523b, 3524a, and 3524b, eight output portions from the top among the 14 output portions of the output unit 1400 may be deactivated.

Referring to FIG. 6D, about 85% of the aerosol generating material is consumed. In this case, in addition to the eight horizontal regions 3521a, 3521b, 3522a, 3522b, 3523a, 3523b, 3524a, and 3524b that are not already in contact with the aerosol generating material, five horizontal regions 3525a, 3525b, 3526a, 3526b, and 3527a disposed therebelow may no longer be in contact with the aerosol generating material. Accordingly, because no current flows through all the horizontal regions 3520a and 3520b, thirteen output portions from the top among the 14 output portions of the output unit 1400 may be deactivated.

In this regard, even when no current flows through all the horizontal regions 3520a and 3520b, a closed loop connected to the power supply 1100, the vertical region 3510a of the first pattern electrode 3500a, the vertical region 3510b of the second pattern electrode 3500b, and again the power supply 1100 may be formed in a lower portion of the horizontal region 3527a located at the lowermost portion such that the current may flow. Accordingly, an output portion located in the lowermost portion among the 14 output portions of the output unit 1400 may remain activated.

Although not shown, when no aerosol generating material is in the storage unit 3100, the entire region of the two pattern electrodes 3500 is not in contact with the aerosol generating material. In this case, because the closed loop is no longer formed, no current may flow through the two pattern electrodes 3500. Accordingly, all the output portions of the output unit 1400 may be deactivated.

The aerosol generating device 1 according to another embodiment may further include a current sensor (not shown). The current sensor may be connected to the pattern electrode 3500. The current sensor may generate a signal in response to a current value or a change in current flowing through the pattern electrode 3500. For example, the current sensor may generate the signal when the current flows through one region of the pattern electrode 3500. In this case, the signal generated by the current sensor may refer to current itself flowing through the current sensor or a signal based on the current.

A control unit (not shown) may determine whether current flows in one region of the pattern electrode 3500 based on the signal generated by the current sensor, and determine the remaining amount of the aerosol generating material stored in the cartridge 300.

Meanwhile, according to another embodiment, the control unit may monitor the remaining amount of the aerosol generating material not only through current but also through a potential difference (voltage). In this case, the aerosol generating device 1 may include a potential difference sensor (voltage sensor).

For example, one end of the potential difference sensor may be connected to the horizontal region 3520a of the first pattern electrode 3500a, and the other end of the potential difference sensor may be connected to one region of the vertical region 3510b of the second pattern electrode 3500b located at the same height from a bottom surface of the storage unit 3100.

As another example, one end of the potential difference sensor may be connected to the horizontal region 3520b of the second pattern electrode 3500b, and the other end of the potential difference sensor may be connected to one region of the vertical region 3510a of the first pattern electrode 3500a located at the same height from the bottom surface of the storage unit 3100.

Because thirteen horizontal regions 3520a and 3520b of the pattern electrode 3500 are disposed, a total of thirteen potential difference sensors may be disposed, but the embodiment is not limited to the number of potential difference sensors described above.

Different voltages may be applied between the horizontal regions 3520a and 3520b and one region of the vertical regions 3510a and 3510b of the same heights as those of the horizontal regions 3520a and 3520b in response to the remaining amount of the aerosol generating material accommodated in the storage unit 3100. In other words, according to whether the horizontal regions 3520a and 3520b and one region of the vertical regions 3510a and 3510b of the same heights as those of the horizontal regions 3520a and 3520b are in contact with the aerosol generating material, the magnitude of the voltage detected by the potential difference sensor may be different.

The potential difference sensor may generate a signal in response to the magnitude of voltages applied to both ends or a change in the voltages. In this case, the signal generated by the potential difference sensor, which is a remaining amount detection sensor, may refer to a voltage itself applied between a plurality of pattern electrodes (e.g., a horizontal region of the first pattern electrode and a part of a vertical region of the second pattern electrode located at the same height as that of the horizontal region) or a signal based on the voltage. In addition, the signal may refer to a voltage itself applied to the potential difference sensor or a signal based on the voltage.

The control unit may determine whether one region of the pattern electrode 3500 is in contact with the aerosol generating material based on the signal generated by the potential difference sensor, and determine the remaining amount of the aerosol generating material stored in the cartridge 300 through the determination.

The control unit may determine the remaining amount of the aerosol generating material and control the operation of the aerosol generating device 1. For example, the control unit may control whether each output portion of the output unit 1400 is activated.

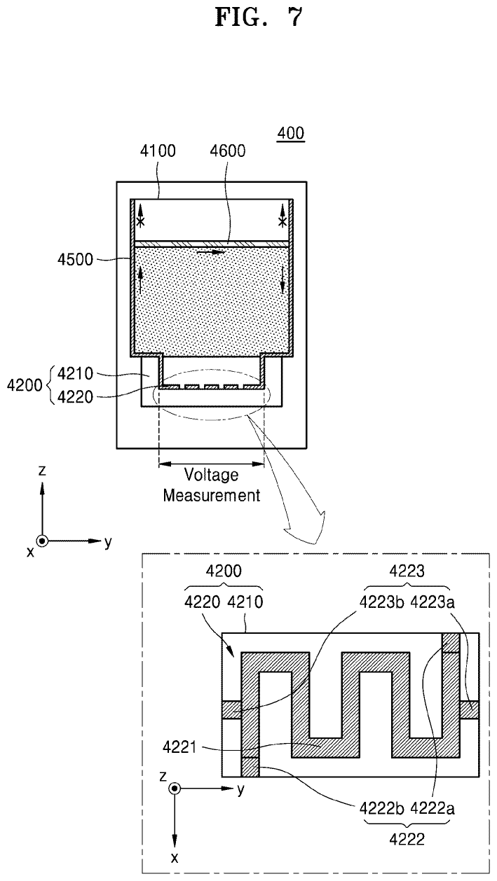

FIG. 7 is a cross-sectional view of a cartridge according to another embodiment to which another example of a technique for monitoring the remaining amount of an aerosol generating material is applied.

Referring to FIG. 7, a cartridge 400 according to another embodiment may include a storage unit 4100, an atomizing unit 4200, an electrode 4500, and a moving member 4600.

The storage unit 4100 performs the same function as described above, and thus a detailed description thereof is omitted.

The atomizing unit 4200 may be disposed in a lower portion of the storage unit 4100 to generate an aerosol from the aerosol generating material discharged to the outside of the storage unit 4100. The aerosol refers to a floating substance in which liquid and/or solid fine particles are dispersed in a gas. Therefore, the aerosol generated from the atomizing unit 4200 may mean a state in which vaporized particles generated from the aerosol generating material and air are mixed.

The atomizing unit 4200 may convert the phase of the aerosol generating material into a gas phase through vaporization and/or sublimation. For example, the atomizing unit 4200 may generate the aerosol by granulating and releasing an aerosol generating material in a liquid and/or solid phase.

Specifically, the atomizing unit 4200 may include a wick 4210 and a heating element 4220. In this regard, the wick 4210 and the heating element 4220 may be respectively the same as or similar to the liquid transfer means and the cartridge heater 24 of FIGS. 2 and 3.

The wick 4210 may receive the aerosol generating material from the storage unit 4100 and absorb the aerosol generating material. The aerosol generating material absorbed into a part of the wick 4210 may move to another part of the wick 4210 according to the capillary phenomenon. For example, the wick 4210 may absorb the aerosol generating material discharged from the storage unit 4100 through both ends thereof, and the absorbed aerosol generating material may move to the center of the wick 4210. As described above, the wick 4210 may transfer the aerosol generating material to the heating element 4220.

The heating element 4220 is a component for atomizing the aerosol generating material absorbed in the wick 4210. For example, the heating element 4220 may heat the aerosol generating material to generate an aerosol from the aerosol generating material.

However, a method performed by the heating element 4220 of atomizing the aerosol is not limited to the ‘heating’ method according to the name of the heating element 4220. As another example, the heating element 4220 may be an ultrasonic vibrator that generates an aerosol from an aerosol generating material by using an ultrasonic vibration method. The ultrasonic vibration method may refer to a method of generating an aerosol by atomizing an aerosol generating material through an ultrasonic vibration generated by a vibrator.

As shown, the heating element 4220 may be attached on the wick 4210, in the form of a pattern. In this case, the heating element 4220 may be permanently or reversibly attached to the wick 4210, such as application, spraying, deposition, plating, dipping, painting, printing, 3D printing, use of equipment, etc., and disposed on the wick 4210.

However, a method in which the heating element 4220 is disposed on the wick 4210 is not limited thereto. As another example, the heating element 4220 may be coupled to the wick 4210 according to a structural characteristic, such as being wound around the wick 4210. As another example, the heating element 4220 may be disposed on the wick 4210 by sintering the heating element 4220 together in a process of manufacturing the wick 4210.

Meanwhile, in general, when the heating element 4220 includes a heating region 4221, and power connection regions 4222a and 4222b, the heating element 4220 of the cartridge 400 according to the embodiment may include the heating region 4221, the power connection regions 4222a and 4222b, and electrode connection regions 4223a and 4223b.

The heating region 4221 is a region for heating the aerosol generating material absorbed in the wick 4210. In this regard, the shape of the heating region 4221 is not limited to that shown. The power connection regions 4222a and 4222b refer to both ends of the heating region 4221, and are regions connected to a terminal to receive power from the power supply of an aerosol generating device.

The electrode connection regions 4223a and 4223b are regions connected to the electrode 4500 disposed in the storage unit 4100. The electrode connection regions 4223a and 4223b may be withdrawn from the heating region 4221 or the power connection regions 4222a and 4222b and extend toward the storage unit 4100 along the wick 4210. In this regard, the shapes of the electrode connection regions 4223a and 4223b are not limited to those shown.

As described above, the electrode 4500 is the component for detecting the remaining amount of the aerosol generating material accommodated in the storage unit 4100, and may be disposed on an inner wall of the storage unit 4100. Specifically, the electrode 4500 may include a first region extending in a longitudinal direction (e.g., z-axis direction) of the storage unit 4100 and disposed on the inner wall of the storage unit 4100, and a second region extending in a direction (e.g., y-axis direction) crossing the longitudinal direction of the storage unit 4100 and disposed on a bottom surface of the storage unit 4100.

Two electrodes 4500 may be disposed in a pair, and disposed to face each other through the first region. Each of the two electrode connection regions 4223a and 4223b of the heating element 4220 may be connected to the second region of the different electrode 4500.

The moving member 4600 is a conductive object movable in the longitudinal direction of the storage unit 4100 in response to the remaining amount of the aerosol generating material accommodated in the storage unit 4100. For example, the moving member 4600 may be disposed inside the storage unit 4100 to float on the aerosol generating material.

The aerosol generating material may be discharged from the storage unit 4100 so that a distance from the bottom surface of the storage unit 4100 to the liquid level of the aerosol generating material may be reduced, and a distance from the bottom surface of the storage unit 4100 to the moving member 4600 may also be reduced. Based on this principle, the moving member 4600 may move in the longitudinal direction (e.g., the z-axis direction) of the storage unit 4100.

The moving member 4600 may be disposed between a pair of electrodes 4500. Both ends of the moving member 4600 may be respectively in contact with the pair of electrodes 4500. Accordingly, a closed loop connected to the heating element 4220, one electrode 4500, the moving member 4600, the other electrode 4500, and again the heating element 4220 may be formed again. Current may flow through the closed loop.

In this regard, even when the moving member 4600 moves in the longitudinal direction of the storage unit 4100, the moving member 4600 may maintain contact with the electrode 4500. Accordingly, even when the liquid level of the aerosol generating material is reduced by consuming the aerosol generating material, the current may flow through the pair of electrodes 4500 and the moving member 4600.

When the moving member 4600 descends due to the reduced liquid level of the aerosol generating material, a part (hereinafter, referred to as a contact part) of the electrode 4500 in contact with both ends of the moving member 4600 may also gradually descend. In this regard, with respect to the contact part, a lower region is included in the closed loop and the current flows, but an upper region has no aerosol generating material so that no closed loop is formed and no current may flow.

When the aerosol generating material is consumed, with respect to the contact part, the lower region may be reduced and the upper region may be increased. Accordingly, a region in which the current flows in the electrode 4500 may be gradually reduced and a region in which no current flows may be gradually increased.

In view of the electrode 4500 as a kind of resistor, when the region in which the current flows in the electrode 4500 is gradually reduced, the length of the resistor is shortened, and thus a resistance value may be reduced. In this regard, when a potential difference sensor (not shown) is connected to the two electrode connection regions 4223a and 4223b and a voltage is measured, the voltage may increase due to the reduced resistance value.

As a result, when the aerosol generating material is consumed, the position of the moving member 4600 may be different, and different voltages may be applied to the electrode 4500 according to the position of the moving member 4600.

Upon monitoring such a voltage change, a control unit (not shown) may determine how much of the aerosol generating material has been consumed based on the monitored voltage change. In other words, the control unit may monitor the remaining amount of the aerosol generating material through the potential difference sensor.

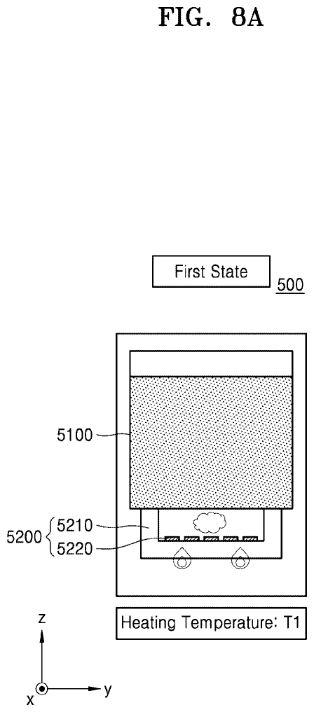

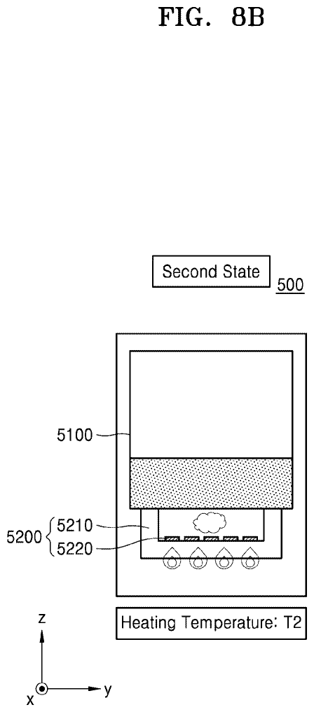

FIGS. 8A and 8B are cross-sectional views of a cartridge according to another embodiment, in which a heating temperature may be adjusted according to the remaining amount of an aerosol generating material.

Referring to FIGS. 8A and 8B, a cartridge 500 according to another embodiment may include a storage unit 5100 and an atomizing unit 5200. Detailed descriptions of the configuration and effect of the cartridge 500 which are redundant are omitted.

According to another embodiment, a control unit of an aerosol generating device may control the atomizing unit 5200 according to the remaining amount of the aerosol generating material stored in the cartridge 500. Specifically, the control unit may adjust a heating temperature of a heating element 5220 disposed on aa wick 5210. Accordingly, the control unit may adjust the amount of atomization of an aerosol generated by the heating element 5220 based on the remaining amount of the aerosol generating material.

Referring to FIGS. 8A and 8B, the heating element 5220 of the cartridge 500 in a first state in which a relatively large amount of the aerosol generating material is stored may be heated to a higher temperature than the heating element 5220 of the cartridge 500 in a second state.

In general, as the aerosol generating material in the storage unit 5100 is consumed, a pressure applied to a bottom surface of the storage unit 5100 decreases, and thus the amount of aerosol generating material discharged from the storage unit 5100 per unit time may decrease. Accordingly, the amount of the aerosol generating material supplied to the wick 5210 is reduced, and thus the amount of the aerosol generated by the heating element 5220 may also be reduced.

In this regard, an increase in the heating temperature of the heating element 5220 may enable to promote atomization of the aerosol generating material absorbed in the wick 5210. Therefore, the amount of atomization when heating to temperature T1 in the first state with a relatively large remaining amount and the amount of atomization when heating to temperature T2 higher than temperature T1 in the second state with a relatively small remaining amount may not be significantly different.

For this reason, the cartridge 500 may maintain a constant amount of atomization even though the remaining amount of the aerosol generating material is gradually reduced. A user may inhale a constant amount of aerosol even when smoking at any time while using the cartridge 500.

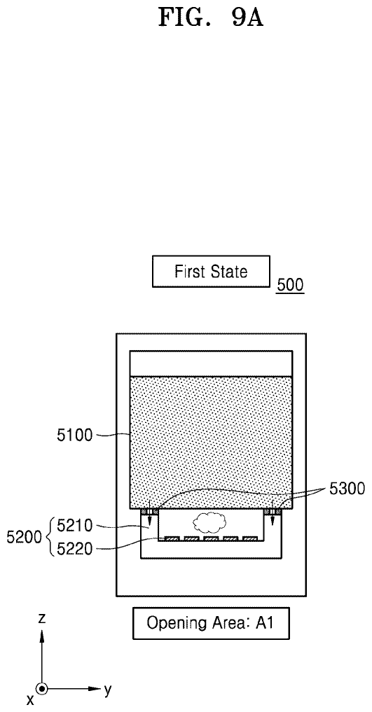

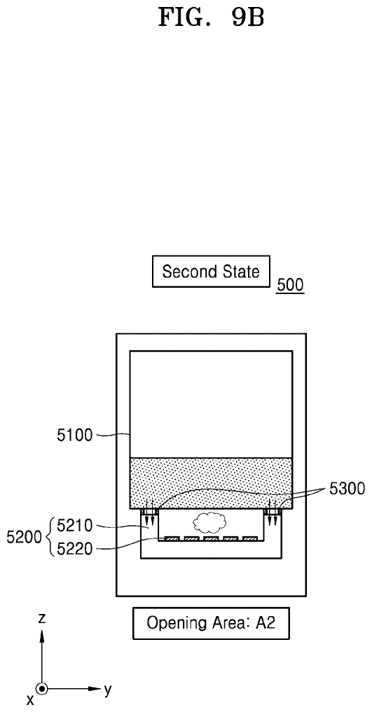

FIGS. 9A and 9B are cross-sectional views of a cartridge according to another embodiment, in which the opening area of an outlet may be adjusted according to the remaining amount of an aerosol generating material.

Referring to FIGS. 9A and 9B, the cartridge 500 according to another embodiment may include the storage unit 5100, the atomizing unit 5200, and a valve 5300. Detailed descriptions of the configuration and effect of the cartridge 500 which are redundant are omitted.

The valve 5300 is a component to open and close the storage unit 5100. Specifically, the valve 5300 may be disposed at the outlet of the storage unit 5100 to open and close the outlet. Accordingly, the valve 5300 may adjust the amount of the aerosol generating material flowing through the outlet of the storage unit 5100. One or more valves 5300 may be disposed to correspond to the number of outlets formed in the storage unit 5100.

According to another embodiment, a control unit of an aerosol generating device may adjust an opening degree of the outlet according to the remaining amount of the aerosol generating material stored in the cartridge 500. Specifically, the control unit may control the valve 5300 disposed at the outlet.

Referring to FIGS. 9A and 9B, the outlet of the cartridge 500 in a first state in which a relatively large amount of the aerosol generating material is stored may be opened more largely than the outlet of the cartridge 500 in a second state.

As described above, as the aerosol generating material in the storage unit 5100 is consumed, the amount of aerosol generating material discharged from the storage unit 5100 per unit time may decrease. For this reason, the amount of a generated aerosol may be reduced.

In this regard, by controlling the valve 5300 to more largely open the outlet, the supply amount of the aerosol generating material to the wick 5210 may be increased. For example, by reducing the opening degree of the outlet in the first state with a relatively large remaining amount and increasing the opening degree of the outlet in the second state with a relatively small remaining amount, even when the remaining amount of the aerosol generating material changes, the amount of aerosol generating material supplied to the wick 5210 may be maintained at a constant level. Therefore, the amount of atomization in the first state with the relatively large remaining amount and the amount of atomization in the second state with the relatively small remaining amount may not be significantly different.

For this reason, the cartridge 500 may maintain a constant amount of atomization even though the remaining amount of the aerosol generating material is gradually reduced. A user may inhale a constant amount of aerosol even when smoking at any time while using the cartridge 500.

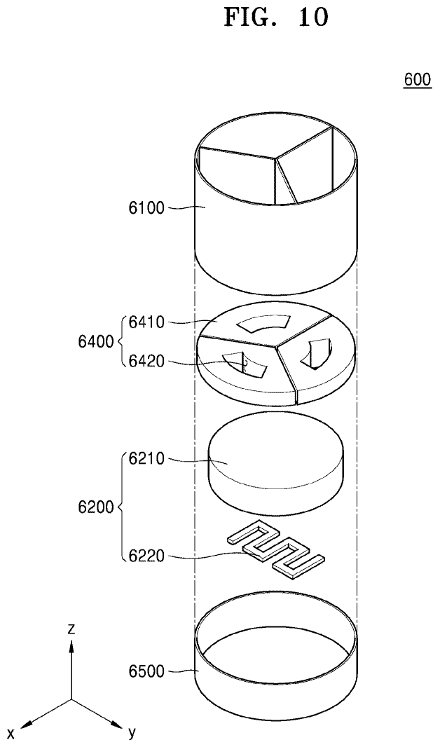

FIG. 10 is an exploded perspective view of a cartridge according to another embodiment storing three types of aerosol generating materials.

Referring to FIG. 10, a cartridge 600 according to another embodiment may include a storage unit 6100, an atomizing unit 6200, a passage member 6400, and an accommodation unit 6500. Detailed descriptions of the configuration and effect of the cartridge 600 which are redundant are omitted.

The storage unit 6100 may include a plurality of storage spaces. The plurality of storage spaces may be divided into partition walls. Different types of aerosol generating materials may be stored in the respective storage spaces. Different types of aerosol generating materials may be separated by partition walls and present separately without mixing inside the storage unit 6100.

According to another embodiment, a lower portion of the storage unit 6100 may be opened. In this regard, the passage member 6400 may be disposed in the lower portion of the storage unit 6100 to block at least a part of the storage unit 6100. However, according to an embodiment, the lower portion of the storage unit 6100 may be blocked, and one or more outlets may be disposed in a bottom surface of the storage unit 6100.

The passage member 6400 is a component to accommodate one or more valves (not shown). The valves may move inside the passage member 6400. The passage member 6400 may guide the movement of the valves.

The passage member 6400 may include a case 6410 forming the exterior appearance of the passage member 6400, and a plurality of openings 6420 through which the aerosol generating materials respectively accommodated in the plurality of storage spaces pass.

The case 6410 may include an empty space therein. A plurality of valves may be accommodated in the empty space and moved. The opening degree of the openings 6420 may be adjusted according to the movement of the valves.

The openings 6420 may be disposed in the same number as the number of storage spaces. Each opening 6420 may be fluidly connected to the storage space corresponding thereto. In this regard, ‘fluid connection’ may mean that elements are connected to each other such that fluid may pass therethrough and flow.

Because the plurality of openings 6420 are spaced apart from each other, different aerosol generating materials discharged from the respective storage spaces may move through the openings 6420 connected to the respective storage spaces without mixing even while passing through the passage member 6400.

The aerosol generating materials passing through the passage member 6400 may reach the atomizing unit 6200. Specifically, the aerosol generating materials may be absorbed into a wick 6210. The different aerosol generating materials supplied to the wick 6210 may be mixed in the wick 6210. One or more types of aerosol generating materials may be atomized into aerosols by a heating element 6220 disposed on the wick 6210.

The wick 6210 may be coupled to a lower portion of the passage member 6400 such that all the aerosol generating materials which have passed through the passage member 6400 may be supplied to the wick 6210. The wick 6210 coupled to the lower portion of the passage member 6400 may cover the openings 6420. Accordingly, the aerosol generating materials discharged through the openings 6420 may be directly supplied to the wick 6210. In this regard, the heating element 6220 may be disposed on the other surface of the wick 6210 opposite to one surface of the wick 6210 in contact with the passage member 6400.

Meanwhile, the embodiment is not limited to the wick 6210 being coupled to the lower portion of the passage member 6400. As another example, the wick 6210 may be spaced apart from the passage member 6400. However, even in this case, the wick 6210 may have a suitable shape such that all the aerosol generating materials which have passed through the passage member 6400 may be supplied to the wick 6210.

The accommodation unit 6500 may be coupled to the storage unit 6100 to form the exterior appearance of the cartridge 600 together with the storage unit 6100. The accommodation unit 6500 may accommodate the atomizing unit 6200 and the passage member 6400. While the atomizing unit 6200 and the passage member 6400 are accommodated in the accommodation unit 6500, the accommodation unit 6500 may be coupled to the storage unit 6100. However, a method of assembling the cartridge 600 is not limited thereto. As another example, the atomizing unit 6200 and/or the passage member 6400 may be accommodated in the lower portion of the storage unit 6100.

Although not shown, the accommodation unit 6500 may include an air inlet (not shown) allowing air to flow in and an aerosol outlet (not shown) for discharging an aerosol generated by the atomizing unit 6200 to the outside of the cartridge 600.

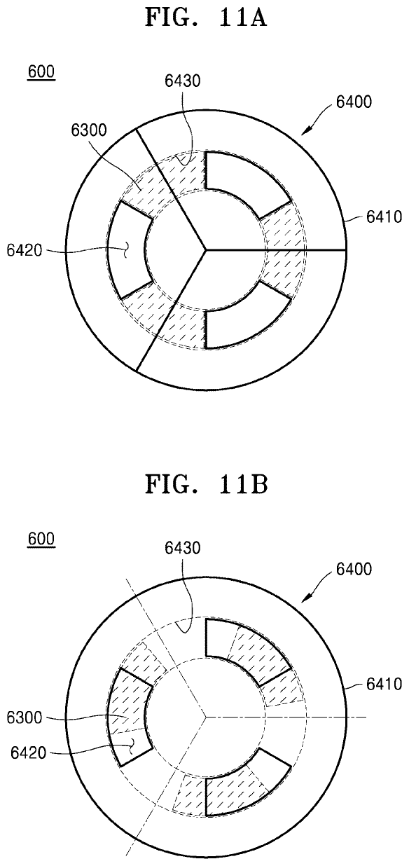

Hereinafter, adjusting an opening degree of the opening 6420 by controlling a valve is described with reference to FIGS. 11A and 11B.

FIG. 11A is a cross-sectional view showing a cartridge shown in FIG. 10 in a first state. FIG. 11B is a cross-sectional view showing the cartridge shown in FIG. 10 in a second state.

Referring to FIGS. 11A and 11B, the cartridge 300 according to another embodiment may include the valve 6300 and the passage member 6400. Detailed descriptions of the configuration and effect of the cartridge 600 which are redundant are omitted.

The valves 6300 may be disposed in the same number as the number of storage spaces of the storage unit 6100. When a plurality of storage spaces are disposed, a plurality of valves 6300 may be disposed in the same number. As shown, because three storage spaces are disposed, the three valves 6300 may be disposed, but the embodiment is not necessarily limited to the number of valves shown.

The plurality of valves 6300 may be disposed in a circumferential direction of the passage member 6400. Each of the plurality of valves 6300 may rotatably operate according to a user input. At least some of the valves 6300 may rotate and move with respect to a central axis of the cartridge 600 in a longitudinal direction (e.g., z-axis direction) to adjust the opening degree of the opening 6420. That is, the opening area of the opening 6420 may be adjusted by the valves 6300.

The passage member 6400 may include one or more rotation grooves 6430 formed inside the case 6410. The rotation grooves 6430 may accommodate the valves 6300. The number of the valves 6300 and the number of the rotation grooves 6430 may correspond to one-to-one, and the valves 6300 and the rotation grooves 6430 may form a pair. In the embodiment, the three valves 6300 and the three rotation grooves 6430 are shown, but the number of valves 6300 and the number of rotation grooves 6430 are not limited thereto.

The opening 6420 may be disposed between the two rotation grooves 6430. That is, the rotation grooves 6430 may separate the opening 6420 into a plurality of openings, and the number of openings 6420 may be the same as the number of the valves 6300 and the number of the rotation grooves 6430. In other words, the number of openings 6420 may be the same as the number of storage spaces. In the embodiment, the three openings 6420 may be disposed.

The valves 6300 may rotate in the circumferential direction of the passage member 6400 with respect to the rotation axis within a preset movement range. The rotation axis is a central axis of the passage member 6400, and the central axis may be spaced apart from the plurality of openings 6420 by the same distance. In this regard, a stopper may be disposed to restrict the movement of the valves 6300. The stopper may physically distinguish the rotation grooves 6430 from the openings 6420, and may determine a rotation movement range of the valves 6300.

Referring to FIG. 11A, the first state of the cartridge 600 in which the valve 6300 is entirely accommodated in the rotation groove 6430 is shown. When the valve 6300 is entirely accommodated in the rotation groove 6430, the opening area of the opening 6420 may be the maximum. In this case, the amount of aerosol generating materials discharged from the storage space per unit time may be maximized.

Referring to FIG. 11B, a second state of the cartridge 600 in which the valve 6300 moves in the circumferential direction of the passage member 6400 and a part of the valve 6300 is accommodated in the rotation groove 6430 is shown. In this regard, the other part of the valve 6300 that is not accommodated in the rotation groove 6430 blocks a part of the opening 6420, so that the opening degree of the opening 6420 may be reduced compared to the first state shown in FIG. 11A. In this case, the amount of the aerosol generating material discharged from the storage space per unit time may be reduced compared to FIG. 11A.

Although not shown in the drawings, when the valve 6300 entirely escapes from the rotation groove 6430, the valve 6300 may entirely block the opening 6420. In other words, when the valve 6300 moves in the circumferential direction of the passage member 6400 and one surface of the valve 6300 facing the circumferential direction of the passage member 6400 meets the stopper or one surface of the opening 6420, the opening 6420 may be closed. In this case, the aerosol generating material may not be discharged from the storage space.

In an example, a user may adjust the opening degree of opening 6420 through the valve 6300 by operating a component mechanically connected to the valve 6300. In another example, the user may adjust the opening degree of the opening 6420 by manipulating the valve 6300 through a control unit of an aerosol generating device electrically connected to the valve 6300.

By adjusting the opening degree of the opening 6420, the user may adjust the amount or speed of the aerosol generating material discharged from the storage unit 6100. In this regard, each of the plurality of valves 6300 may be adjusted. Accordingly, the user may inhale an aerosol by mixing aerosol generating materials according to a user's preference.

When the aerosol generating device has a function of monitoring the remaining amount of the aerosol generating material, the control unit may determine the remaining amount of the aerosol generating material stored in the storage unit 6100 and operate the valve 6300 based on the remaining amount.

That is, the opening degree of the opening 6420 may be adjusted in response to a change in the remaining amount of the aerosol generating material. In this regard, the remaining amount of the aerosol generating material stored in each of the three storage spaces may be monitored.

Meanwhile, the valve 6300 may be omitted according to an embodiment. In this case, the storage unit 6100 may include an outlet corresponding to the shape of the opening 6420 in the bottom surface. When the user rotates the storage unit 6100 with respect to the passage member 6400 or rotates the passage member 6400 with respect to the storage unit 6100, the outlet and the opening 6420 overlap to adjust a region through which the aerosol generating material is discharged, and thus the user may adjust the opening degree of the opening 6420.

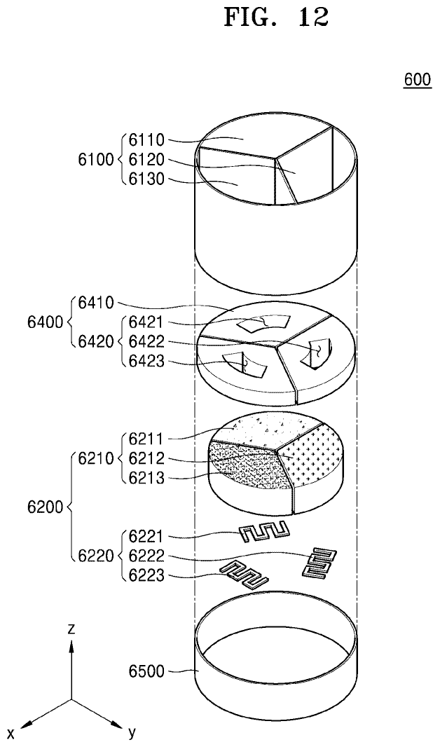

FIG. 12 is an exploded perspective view of a cartridge according to another embodiment capable of heating each of three types of aerosol generating materials.

Referring to FIG. 12, the cartridge 600 according to another embodiment may include the storage unit 6100, the atomizing unit 6200, the passage member 6400, and the accommodation unit 6500. Detailed descriptions of the configuration and effect of the cartridge 600 which are redundant are omitted.

Compared with the cartridge 600 shown in FIG. 10, a plurality of atomizing units 6200 may be disposed on the cartridge 600 shown in FIG. 12. As shown, three wicks 6210 and three heating elements 6220 may be disposed.

Accordingly, the three pairs of wicks 6210 and heating elements 6220 may absorb different types of aerosol generating materials and generate aerosols therefrom. For example, a first aerosol generating material stored in a first storage space 6110 may only move through a first opening 6421 and be supplied to a first wick 6211 and heated by a first heating element 6221.

Likewise, a second aerosol generating material stored in a second storage space 6120 may move only through a second opening 6422, and be supplied only to a second wick 6212 and heated by a second heating element 6222.

To this end, storage spaces, the openings 6420, the wicks 6210, and the heating elements 6220 need to be aligned in a line in a longitudinal direction (e.g., z-axis direction) of the cartridge 600. For example, a third storage space 6130 storing a third aerosol generating material, a third opening 6423, a third wick 6213, and a third heating element 6223 may be aligned in a line.

Unlike the embodiment of FIG. 10 in which aerosol generating materials passing through the passage member 6400 are mixed in the wick 6210, in the embodiment of FIG. 12, different types of aerosol generating materials may not be mixed with each other until atomized into aerosols. The aerosols generated from different types of aerosol generating materials may be mixed inside the accommodation unit 6500 and sucked into a user.

Accordingly, it is possible to prevent a problem that may occur when aerosol generating materials are atomized into aerosols while the aerosol generating materials are mixed with each other. For example, it is possible to prevent a problem in that the taste is unexpectedly changed when aerosol generating materials are mixed with each other. As another example, it is possible to prevent a problem in that the taste deteriorates when components of aerosol generating materials are changed through their chemical reactions, etc.

According to the cartridge and the aerosol generating device including the same according to the embodiments, convenience of use may be improved by providing information about the remaining amount of aerosol generating article stored in the cartridge.

In addition, according to the cartridge and the aerosol generating device including the same according to the embodiments, a constant amount of atomization may be maintained even when the remaining amount of aerosol generating article is changed.

Certain embodiments or other embodiments of the present disclosure described above are not exclusive or distinct from each other. The certain embodiments or other embodiments of the present disclosure described above may be combined with each other or used in combination with each other in their respective components or functions.

For example, it means that an A component described in a specific embodiment and/or the drawings and a B component described in another embodiment and/or the drawings may be combined with each other. In other words, even when it is not explained directly about combination between components, it is possible to combine unless it is explained that combination is impossible.

The above detailed description should not be interpreted restrictedly but should be considered illustrative in all aspects. The scope of the present disclosure should be determined by a rational interpretation of the attached claims, and all changes within the equivalent scope of the present disclosure are included in the scope of the present disclosure.

According to the cartridge and the aerosol generating device including the same according to the embodiments, convenience of use may be improved by providing information about the remaining amount of aerosol generating article stored in the cartridge.

In addition, according to the cartridge and the aerosol generating device including the same according to the embodiments, the user may use the aerosol generating device in the optimal state in relation to the remaining amount of aerosol generating article.

Effects of the present disclosure are not limited to the above effects, and effects that are not mentioned could be clearly understood by one of ordinary skill in the art from the present specification and the attached drawings.

What is claimed is:

1. A cartridge comprising:
a storage unit accommodating an aerosol generating material;
an atomizing unit configured to generate an aerosol from the aerosol generating material; and
a plurality of electrodes disposed inside the storage unit and configured to detect a remaining amount of the aerosol generating material accommodated in the storage unit.

2. The cartridge of claim 1, wherein the plurality of electrodes are disposed on an inner wall of the storage unit.

3. The cartridge of claim 1, wherein
the plurality of electrodes include: a first electrode spaced apart from a bottom surface of the storage unit by a first distance; and a second electrode spaced apart from the bottom surface of the storage unit by a second distance different from the first distance,
each of the first electrode and the second electrode is capable of coming into contact with the aerosol generating material, according to the remaining amount of the aerosol generating material accommodated in the storage unit, and
when each of the first electrode and the second electrode is in contact with the aerosol generating material, current flows between the first electrode, the aerosol generating material, and the second electrode.

4. The cartridge of claim 1, wherein
the plurality of electrodes include a reference electrode and an operation electrode, and
different voltages are applied between the reference electrode and the operation electrode, according to the remaining amount of the aerosol generating material accommodated in the storage unit.

5. The cartridge of claim 1, wherein
the plurality of electrodes are disposed in a certain pattern on an inner wall of the storage unit,
the pattern includes a vertical region extending in a longitudinal direction of the storage unit, and a plurality of horizontal regions extending in a direction crossing the longitudinal direction of the storage unit from the vertical region and spaced apart from each other, and
the pattern includes a first pattern and a second pattern which are disposed to face each other and do not cross each other, and the plurality of horizontal regions of the first pattern and the plurality of horizontal regions of the second pattern are alternately disposed in the longitudinal direction of the storage unit.

6. The cartridge of claim 5, wherein
at least one of the plurality of horizontal regions of the first pattern and the vertical region of the second pattern are capable of coming into contact with the aerosol generating material, according to the remaining amount of the aerosol generating material accommodated in the storage unit, and
when each of the at least one of the plurality of horizontal regions of the first pattern and the vertical region of the second pattern is in contact with the aerosol generating material, current flows between the at least one of the plurality of horizontal regions of the first pattern, the aerosol generating material, and the vertical region of the second pattern.

7. The cartridge of claim 1, further comprising: a moving member movable in a longitudinal direction of the storage unit in response to the remaining amount of the aerosol generating material accommodated in the storage unit,
wherein different voltages are applied to the plurality of electrodes according to a position of the moving member.

8. The cartridge of claim 1, further comprising: one or more valves configured to open and close the storage unit.

9. The cartridge of claim 8, wherein
the storage unit includes a plurality of storage spaces,
the cartridge further comprising: a passage member disposed in a lower portion of the storage unit and including a plurality of openings through which aerosol generating materials respectively accommodated in the plurality of storage spaces pass, and
wherein the passage member is configured to accommodate the one or more valves and guide movement of the one or more valves.

10. The cartridge of claim 9, wherein
the number of the one or more valves is the same as the number of the plurality of storage spaces,
each of the one or more valves is configured to rotatably operate according to a user input, and
an opening area of the plurality of openings is controlled according to operations of the one or more valves.

11. An aerosol generating device comprising:
the cartridge of claim 1; and
a control unit electrically connected to the plurality of electrodes,
wherein the control unit is configured to, in response to a signal generated by the plurality of electrodes, determine a remaining amount of an aerosol generating material accommodated in the storage unit, and, based on the remaining amount, control operation of the aerosol generating device.

12. The aerosol generating device of claim 11, further comprising: an output unit configured to indicate the remaining amount of the aerosol generating material accommodated in the storage unit,
wherein the control unit is configured to control an output of the output unit, based on the remaining amount.

13. The aerosol generating device of claim 11, wherein the control unit is configured to, based on the remaining amount, adjust an amount of atomization of an aerosol generated by the heating element.

14. The aerosol generating device of claim 11, wherein the signal generated by the plurality of electrodes is a signal based on current flowing through the plurality of electrodes.

15. The aerosol generating device of claim 11, further comprising: a remaining amount detection sensor configured to generate a signal in response to a change in the remaining amount of the aerosol generating material accommodated in the storage unit,
wherein the control unit is configured to, when the remaining amount detection sensor generates a signal in response to the signal generated by the plurality of electrodes, determine the remaining amount of the aerosol generating material accommodated in the storage unit, based on the signal generated by the remaining amount detection sensor, and
the signal generated by the remaining amount detection sensor is a signal based on a voltage applied between the plurality of electrodes.
